(19) United States
(12) Patent Application Publication
(10) Pub. No.: US 2011/0256328 A1
(43) Pub. Date: Oct. 20, 2011

(54) THREE-DIMENSIONAL DECORATION KIT

(75) Inventor: Lori Greiner, Chicago, IL (US)

(73) Assignee: FOR YOUR EASE ONLY, INC., Chicago, IL (US)

(21) Appl. No.: 12/850,916

(22) Filed: Aug. 5, 2010

Related U.S. Application Data
(60) Provisional application No. 61/325,611, filed on Apr. 19, 2010.

(51) Int. Cl. B32B 1/06; B32B 3/06

(52) U.S. Cl. 428/34.6; 428/99

(57) ABSTRACT

A configurable three-dimensional decorative kit is provided having a serving platter and a three-dimensional ceramic decoration removably coupled to a surface of the serving platter. The three-dimensional ceramic decoration depicts a food item or items.

Known decorative items have three-dimensional decorations placed thereon. For example, as shown in FIGS. 1-4, various decorative plates have a cluster of three-dimensional fruit located on a portion of the plate. These decorations are decided by the designer and then fixed on the plate and offered for sale to the consumer. The consumer decides whether she likes the particular decorations and, if so, purchases the plate. If the consumer decides to change decorations, she has to purchase a different plate because the decorations are fixed to the plate. Oftentimes, these plates are for decoration only and can not be used to serve food.

### BRIEF DESCRIPTION OF THE DRAWINGS

FIGS. 1-4 illustrate prior art decorations.

FIG. 5 is a perspective view of an assembled kit according to an embodiment of the invention.

FIG. 6 shows the kit of FIG. 5 in an unassembled form.

FIG. 7 is a perspective view of an assembled kit according to another embodiment of the invention.

FIG. 8 is a blown up view of a portion of the kit according to another embodiment of the invention.

FIG. 9 is a blown up view of a portion of the kit according to another embodiment of the invention.

FIG. 10 is a perspective view of the coupling mechanism shown in FIGS. 8 and 9.

FIGS. 11-15 are perspective views of various examples of three-dimensional decorations.

FIG. 16-20 are perspective views of decorations according to another embodiment of the invention.

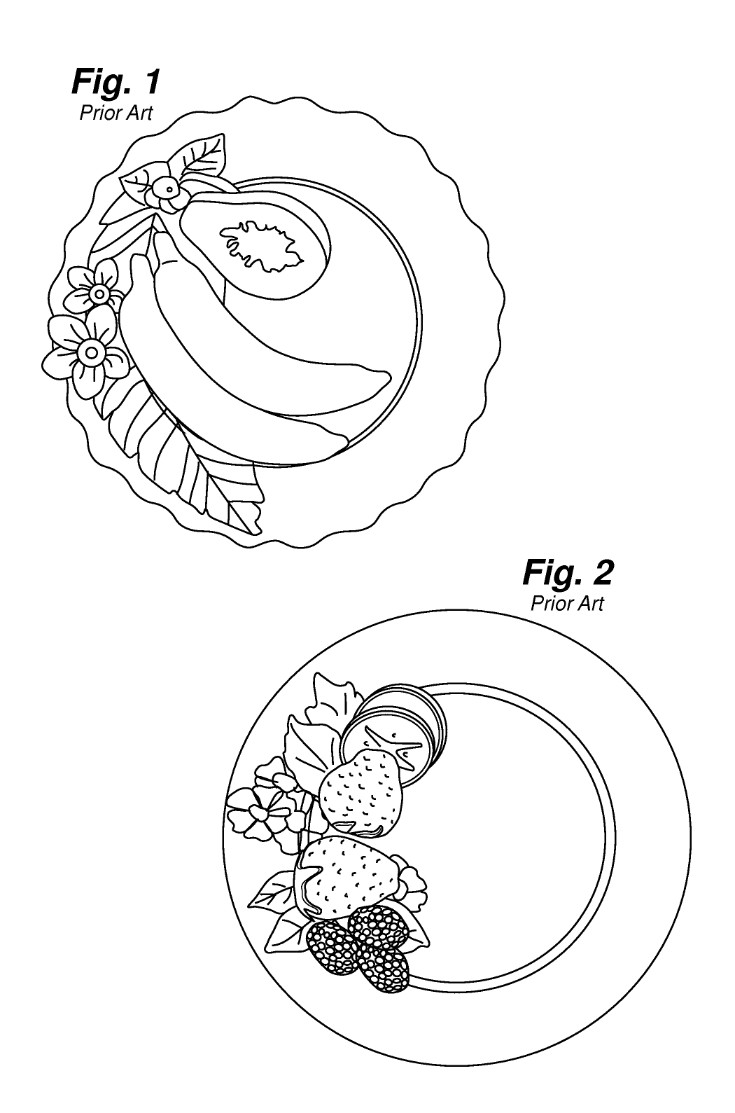

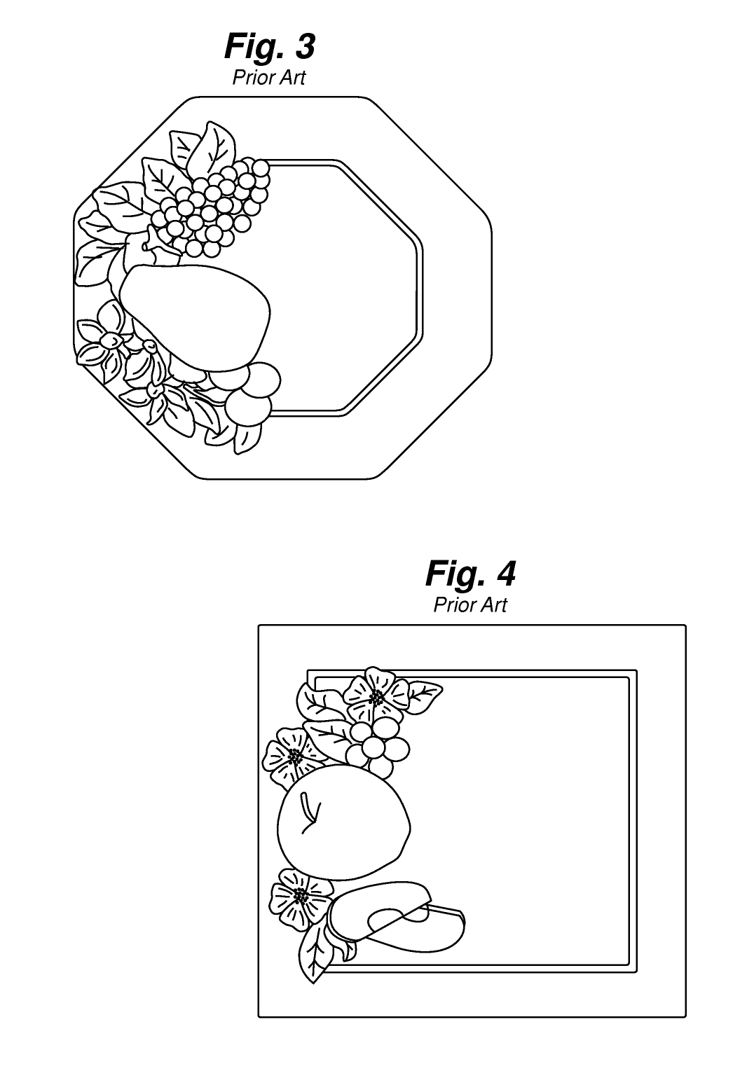

### DETAILED DESCRIPTION OF THE EMBODIMENTS OF THE INVENTION

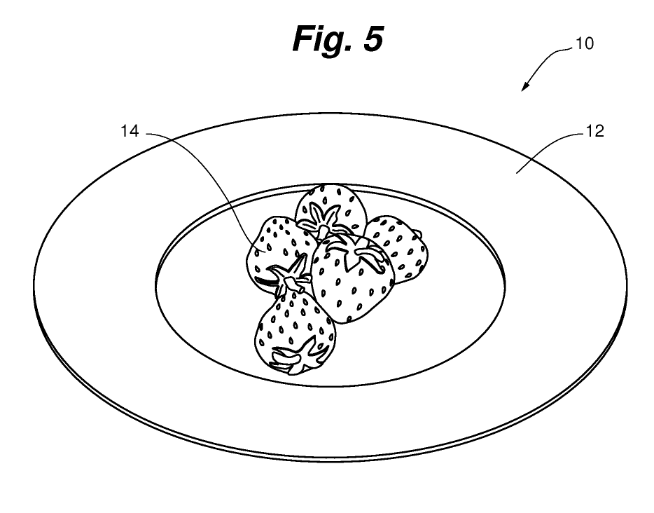

FIG. 5 is perspective view of an assembled kit according to an embodiment of the invention. The kit 10 includes a serving platter 12 and a three-dimensional decoration 14. The serving platter 12 is preferably usable to serve food items thereon. The three-dimensional decoration 14 is preferably ceramic, like the serving platter 12, but may be made of other materials such as plastic or wood, for example, as may the serving platter 12.

The decoration 14 in this illustrated embodiment is located in the center of the serving platter 12, however, it may be located in other areas as will be illustrated and discussed. The decoration 14 is removable from the serving platter and may be replaced with a different decoration as will be discussed to change the look of the serving platter 12. Preferably the decoration 14, as well as all of the decorations described herein, represent food items, such as fruits, vegetables, shellfish, cakes, cupcakes, bonbons, for example, as well as clusters of such food items. The decoration 14 may also representative other three-dimensional objects such as candles, figurines, and messages, for example.

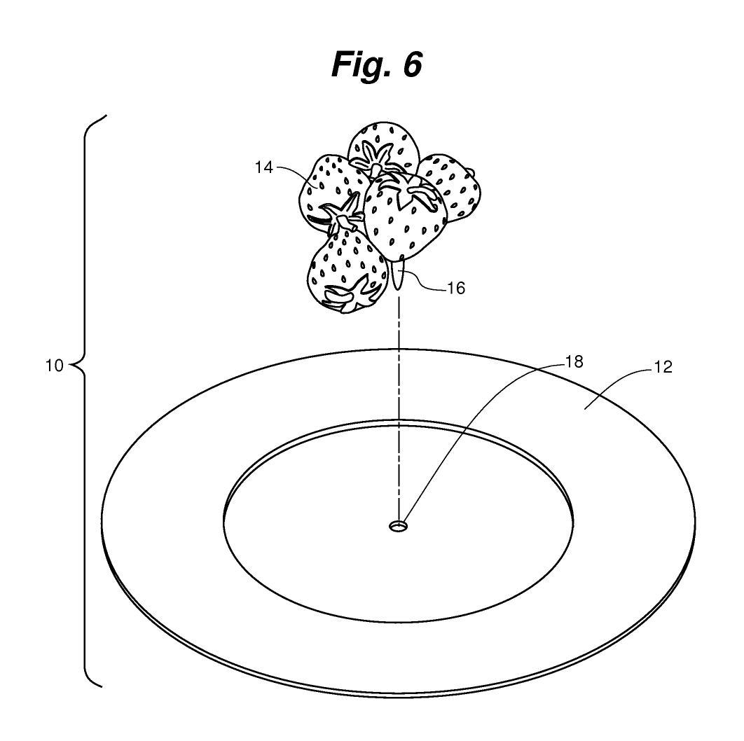

FIG. 6 shows the kit of FIG. 5 in an unassembled form. The decoration 14 is shown detached from the serving platter 12. In one embodiment, the decoration 14 has a stopper 16 coupled to its underside. The stopper 16 may be a cork-like device or it may be made of a rubberized plastic. The serving platter 12 has a receptacle 18 located in its center for receiving the stopper 16 in a frictional fit to couple the decoration 14 to the serving platter 12. In one embodiment, the receptacle is a cavity formed in the platter 12. In another embodiment, the receptacle 18 may be a hole that extends through the platter 12. The receptacle 18 may or may not be lined with a liner such as a rubberized liner. To remove the decoration 14, one simply pulls it away from the platter 12. One can replace the decoration with another decoration to change the look of the platter. Because the decoration is removable, the platter 12 can be stored with other serving pieces.

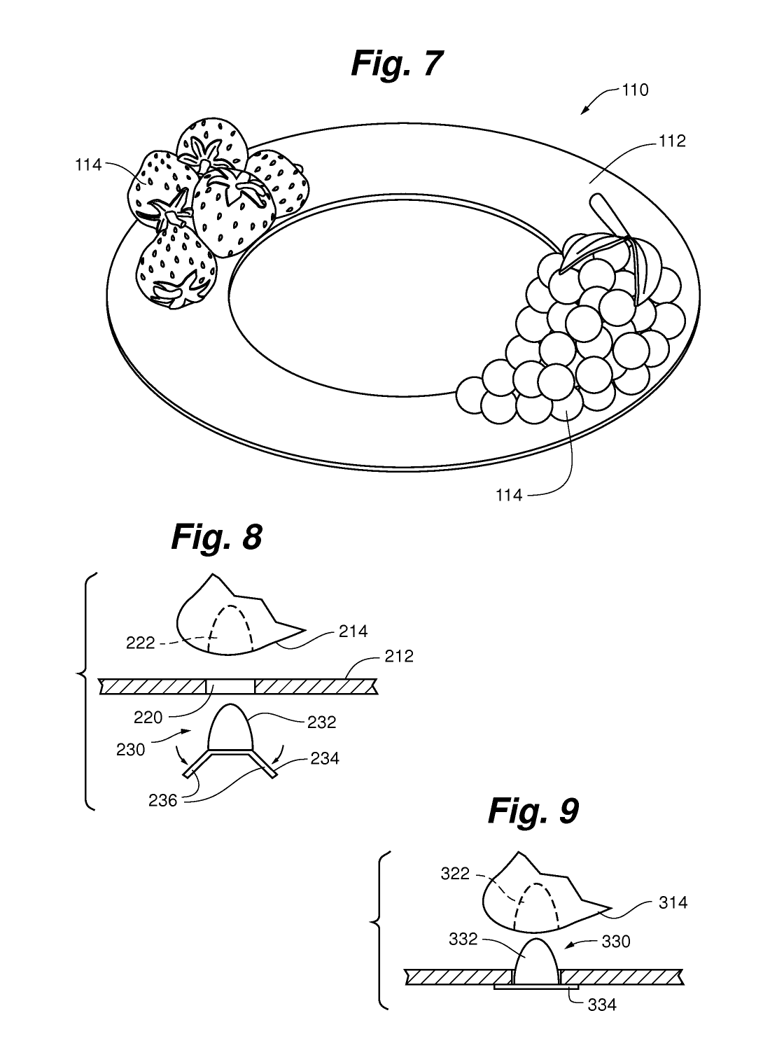

FIG. 7 is a perspective view of an assembled kit 100 according to another embodiment of the invention. In this embodiment, two independent decorations 114 are provided and located at two distinct locations on the periphery of the platter 112. Any of the coupling mechanisms described herein may be used with these decorations 114 and platter 112. In addition to the decorations 114 being three-dimensional focal objects, they may also be functional items such as handles, for example, that can be switched from silver to gold to clear Lucite, for example. In addition, instead of one hole in the platter being provided for each decoration, two holes may be provided, for example, to accommodate pegs or stoppers at each end of the handle.

FIG. 8 is a blown up view of a portion of the kit according to another embodiment of the invention. Instead of using a stopper/receptacle combination as shown in FIG. 5 as the coupling mechanism, FIG. 8 illustrates a coupling mechanism 230 separate from the serving platter 212 and decoration 214. In this embodiment, the serving platter 212 is provided with a hole 220 some place on the platter 212, for example, at its center or located at one or more points around its periphery. The decoration 214 has provided on its underside a receptacle 222 for receiving a portion of the coupling mechanism 230.

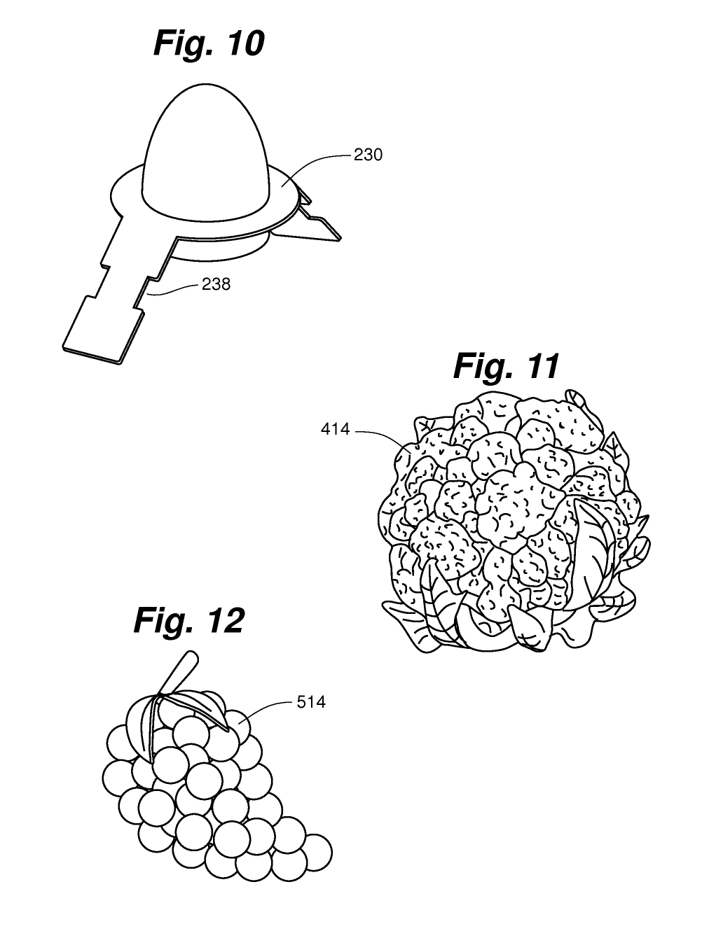

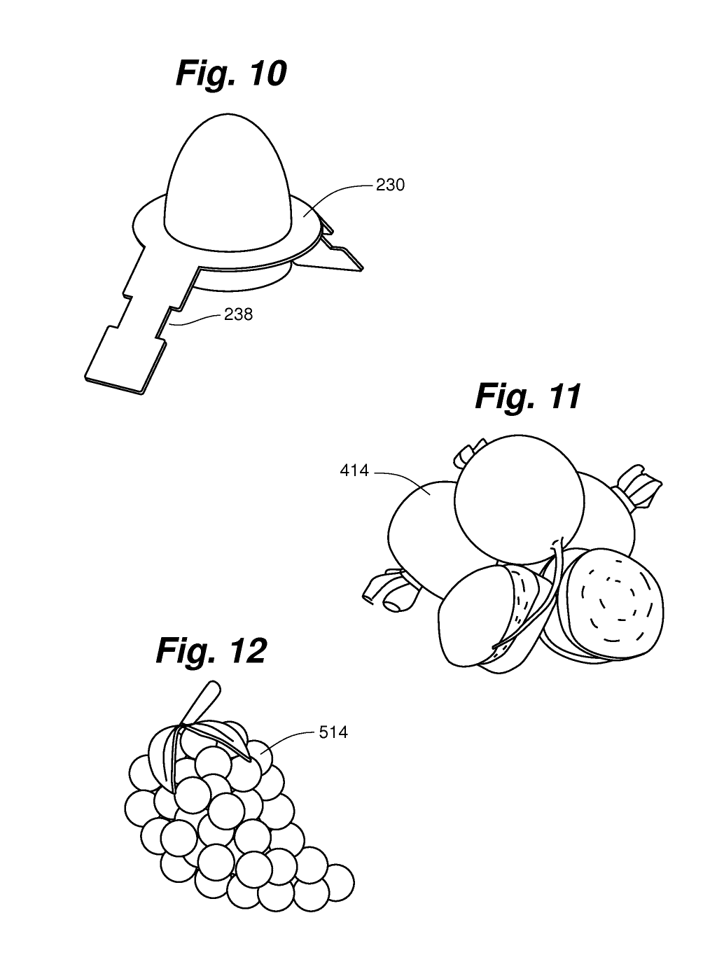

The coupling mechanism 230 includes a stopper 232 and an anchoring mechanism 234 coupled to the stopper 232. In a preferred embodiment the anchoring mechanism 234 includes a ring that encircles the stopper 232 from which a pair of wings 236 extend. The anchoring mechanism 234 is preferably made of a resilient material such as metal or plastic. The pair of wings 236 are biased away from the stopper 232 as shown in FIG. 8. The pair of wings 236 each have a notch 238 formed therein (see FIG. 10).

To couple the decoration 214 to the serving platter 212, one applies force to the wings 236 to bring the wings 236 together as shown in FIG. 9. The stopper 232 is fitted through the hole 220 in the platter 212 as is a portion of the anchoring mechanism 234. When force is removed from the wings 236, the notches 238 in each wing 236 engage the periphery of the hole 220 because of the bias of the wings. This holds the coupling mechanism 230 to the platter 212. The receptacle 222 in the decoration 214 is placed over the stopper 232 of the coupling mechanism. The receptacle 222 and/or stopper 232 may have rubberized material therein to enhance the frictional fit between the two or any other known way of enhancing the coupling between the recess 222 and stopper 232. To remove the decoration 214, it is simply lifted off from the stopper 232. Another decoration 214 may be put in its place. Also, to remove the coupling mechanism 230, force is applied to the wings 236 as indicated by arrows 240. By doing this, the notches 238 in the wings 236 disengage from the periphery of the hole in the platter 212 so that the coupling mechanism 230 can be removed. There should be sufficient room underneath the platter 212 to accommodate the coupling mechanism 230 when it is attached to the platter 212.

FIG. 9 is a blown up view of a portion of the kit according to another embodiment of the invention. In this embodiment, the coupling mechanism 330 is simply a stopper 332 with a ledge 334 at one end thereof that has a diameter larger than the hole 320 in the platter 312 so that it abuts the platter 312 when the stopper 332 is fully inserted in the hole.

FIG. 10 is a perspective view of the coupling mechanism 230 shown in FIG. 8.

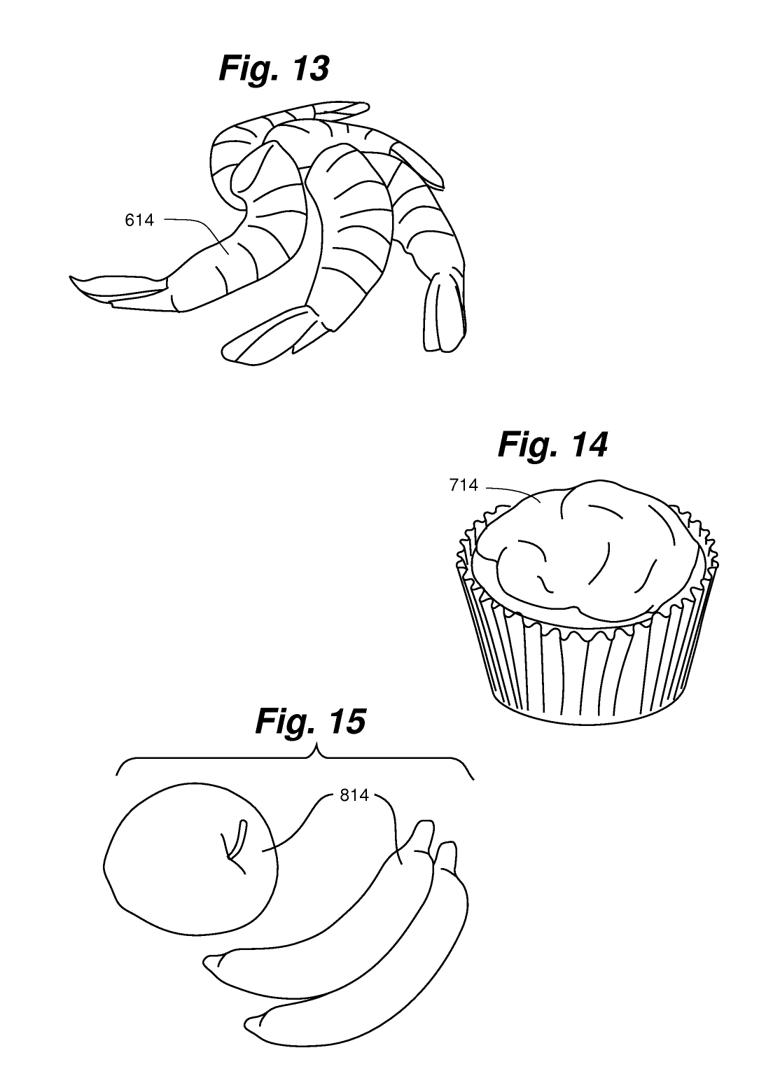

FIGS. 11-15 are perspective views of various examples of three-dimensional decorations. FIG. 11 shows a vegetable cluster decoration 414, FIG. 12 shows a fruit cluster decoration 514, FIG. 13 shows a shell fish decoration 614, FIG. 14 shows a dessert decoration 714 and FIG. 15 shows a pair of fruit decorations 814.

Because the decorations may be removed from the platter and replaced with other decorations, the user of the plate may configure the serving plate so as desired. For example, if dessert is being served on the serving platter, the user may choose a three-dimensional cake decoration, for example. If fruit is being served, she may choose a fruit cluster decoration.

Also, because the decorations are removable, the serving platter may be stored with other serving ware since it takes up less room without the decoration.

The serving platter may have many different shapes and may be made out of many materials such as ceramic, wood, plastic, for example.

In this embodiment, a plurality of receptacles (not shown) are provided in the periphery of the platter 112 instead of its center and a plurality of decorations 114 are received therein.

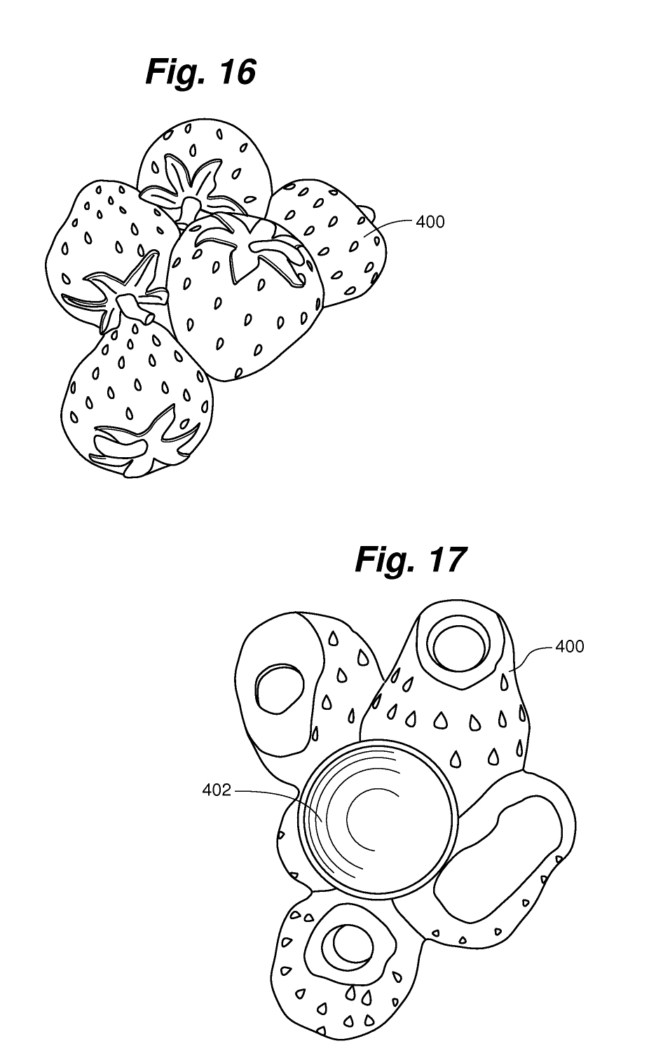

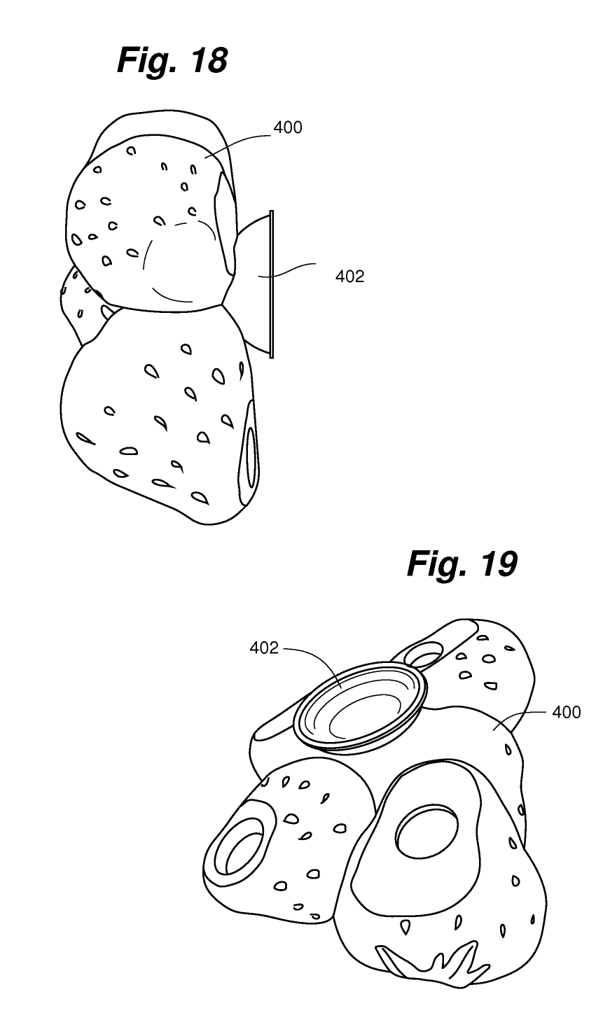

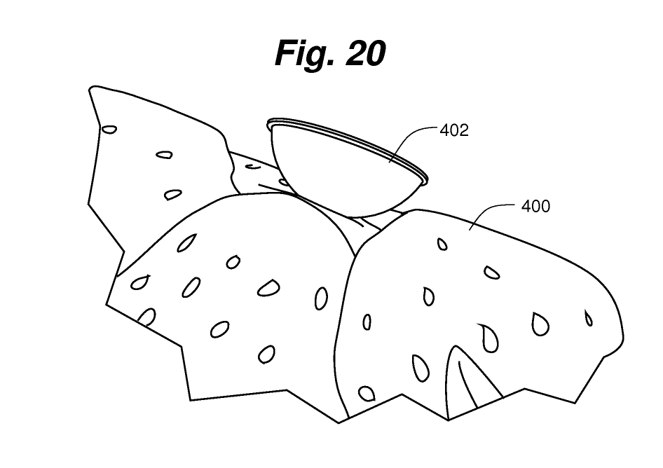

FIGS. 16-20 are perspective views of decorations 400 according to another embodiment of the invention. The decorations in the embodiment are shown as a cluster of strawberries, however, it could be any decoration. FIG. 17 is a bottom perspective view of the decoration 400. Located on the bottom of decoration 400 is a suction cup 402 which is used to adhere the decoration 400 to a serving platter, for example. Of course, any of the decorations described herein can be outfitted with a suction cup coupler as the attachment mechanism.

What is claimed is:

1. A configurable three-dimensional decorative kit comprising:
a serving platter; and
a three-dimensional ceramic decoration removably coupled to a surface of the serving platter.

2. The kit according to claim 1 wherein the surface of the serving platter has a receptacle and the decoration has a stopper that frictionally fits within the receptacle to hold the decoration to the serving platter.

3. The kit according to claim 1 further comprising a suction cup located on a bottom of the decoration to removably couple the decoration to the serving platter.

4. A configurable three-dimensional decorative kit comprising:
a serving platter;
a removable and replaceable three-dimensional ceramic decoration; and
a coupling mechanism for coupling the three-dimensional decoration to a surface of the serving platter.

5. The kit according to claim 4 wherein the coupling mechanism comprises a receptacle in the surface of the serving platter and a stopper located on the decoration that frictionally fits within the receptacle.

6. The kit according to claim 5 wherein the serving platter has a center and the receptacle is located in the center of the serving platter.

7. The kit according to claim 5 wherein the serving platter has a periphery and at least one receptacle is located at the periphery of the serving platter.

8. The kit according to claim 7 wherein a plurality of receptacles are located at the periphery of the serving platter and a plurality of three-dimensional decorations are provided.

9. The kit according to claim 4 wherein the coupling mechanism comprises:
a stopper; and
an anchoring mechanism coupled to the stopper, the anchoring mechanism having a pair of resilient wings that are biased away from the stopper wherein the wings can be manipulated against their bias towards the stopper so that the stopper can be placed through a hole in the serving platter as well as a portion of the wings and once a portion of the wings extend through the hold force is removed from the wings so that they are biased away from the stopper and engage the hole in the platter to fix the coupling mechanism to the serving platter and to remove the coupling mechanism, the wings are manipulated against their bias toward the stopper so that the hold is released and can not be removed with out applying force to the wings to bring them towards one another and the decoration has a receptacle into which the stopper fits.

10. The kit according to claim 9 wherein the three-dimensional decoration represents a food article.

11. The kit according to claim 4 wherein the coupling mechanism is a suction cup located on a bottom surface of the three-dimensional decoration.

12. The kit according to claim 1 further comprising a coupling mechanism for coupling the three-dimensional ceramic decoration to the serving platter.

13. The kit according to the claim 12 wherein the coupling mechanism comprises:
a stopper; and
an anchoring mechanism coupled to the stopper, the anchoring mechanism having a pair of resilient wings that are biased away from the stopper wherein the wings can be manipulated against their bias towards the stopper so that the stopper can be placed through a hole in the serving platter as well as a portion of the wings and once a portion of the wings extend through the hold force is removed from the wings so that they are biased away from the stopper and engage the hole in the platter to fix the coupling mechanism to the serving platter and to remove the coupling mechanism, the wings are manipulated against their bias toward the stopper so that the hold is released and can not be removed with out applying force to the wings to bring them towards one another and the decoration has a receptacle into which the stopper fits.

14. The kit according to claim 1 wherein the three-dimensional ceramic decoration is a depiction of a food item or items.

15. The kit according to claim 4 wherein the three-dimensional ceramic decoration is a depiction of a food item or items.

16. A three-dimensional decorative item comprising:
a coupling means located on the item for selectively coupling the item to a serving vessel.

17. The item according to claim 16 wherein the coupling means is a stopper located on a bottom of the item that fits within a receptacle on the serving vessel.

18. The item according to claim 16 wherein the coupling means is a suction cup located on a bottom of the item.

19. The item according to claim 16 wherein the item is a depiction of a food item or items.
